(19) United States
(12) Patent Application Publication
(10) Pub. No.: US 2009/0312894 A1
(43) Pub. Date: Dec. 17, 2009

(54) METHOD, SYSTEM, AND COMPUTER READABLE STORAGE MEDIUM FOR CONTROLLING ENGINE STARTS

(75) Inventors: Mikhail Meltser, Buffalo Grove, IL (US); Tim Medema, Algonquin, IL (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: GENERAL ELECTRIC COMPANY, Schenectady, NY (US)

(21) Appl. No.: 12/141,008

(22) Filed: Jun. 17, 2008

(51) Int. Cl. G06F 7/00

(52) U.S. Cl. 701/19; 701/1

(57) ABSTRACT

Systems, methods, and computer readable storage media are described for a vehicle, such as a locomotive. In one example, a system comprises an automatic engine start/stop control system configured to automatically start the engine at a selected clock time.

### FIELD

The subject matter disclosed herein relates to a method, system, and computer readable storage medium for automatically starting an engine in a vehicle, such as a locomotive.

### BACKGROUND

Locomotives may be operated to provide scheduled services wherein they are scheduled to depart at a fixed time and/or at fixed time intervals. Accordingly, a locomotive engine and associated electronic systems are started in advance of the scheduled time of departure to enable a comprehensive check of engine and system operational parameters, and to enable the locomotive to be prepared and/or positioned for service.

In one example, commuter trains are often scheduled to start at early morning hours. Consequently, service personnel are required to arrive at a train yard significantly earlier in order to monitor and start the engine of the locomotives parked at the yard and initiate preparation procedures. The use of human intervention in the management of a locomotive engine and associated engine control systems may thereby introduce unwanted errors and delays that may adversely affect the ability of the locomotive to depart at the stipulated time, and may increase overall operation costs.

### BRIEF DESCRIPTION OF THE INVENTION

Methods, systems, and computer readable media are provided for automatically starting an internal combustion engine in a vehicle, such as a locomotive, at a desired time and/or after a desired time interval. In one embodiment, a system comprises an automatic engine start/stop control system configured to automatically start the engine at a selected clock time. For example, the engine can be automatically started at the appropriate time to improve adherence to operating schedules, without requiring human intervention.

In another embodiment, a method of automatically starting an engine of a locomotive operating on a schedule comprises: during locomotive shut-down conditions, monitoring a locomotive operating parameter, and automatically starting the engine when a locomotive operating parameter falls outside a desired condition, and then stopping the engine when the locomotive operating parameter regains its desired condition. Further, at a selected clock time, and if the engine is currently stopped, the method includes starting the engine, and then maintaining the engine operating for at least a selected duration, independent of the locomotive operating parameter. Alternatively, at the selected clock time, and if the engine is currently running, the method includes maintaining the engine operating for at least the selected duration, independent of the locomotive operating parameter. In this way, the automatic engine starting used to maintain operating parameters within desired conditions can be coordinated with the clock-scheduled automatic starting. In still another embodiment, a computer readable storage medium of a locomotive control system may be programmed with code to perform various operations, such as those noted above.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows an example embodiment of a diesel-electric locomotive.

FIG. 2 shows a high level flow chart for a system configured to automatically start/stop an engine.

FIG. 3 shows a high level flow chart for a system configured with an alarm clock and/or sleeper function, according to the present disclosure.

### DETAILED DESCRIPTION

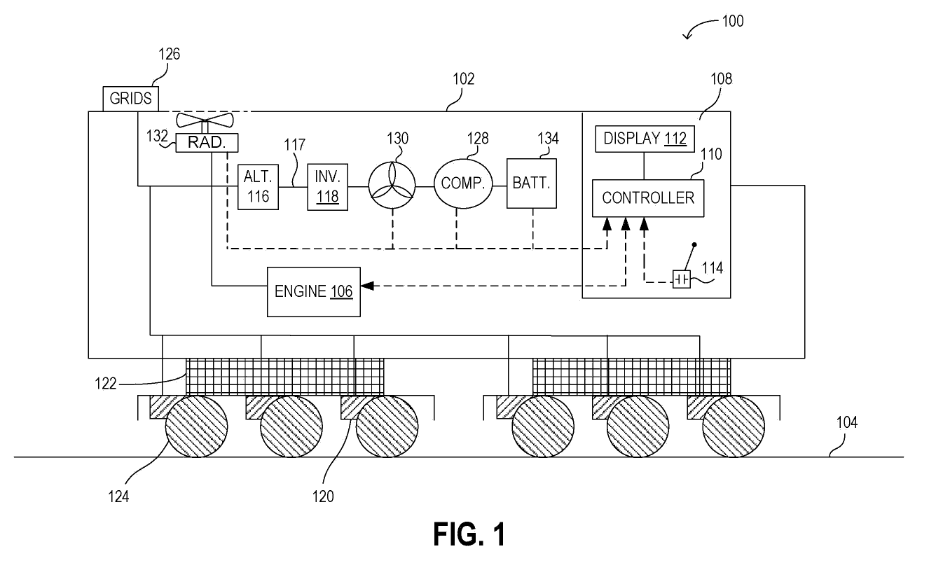

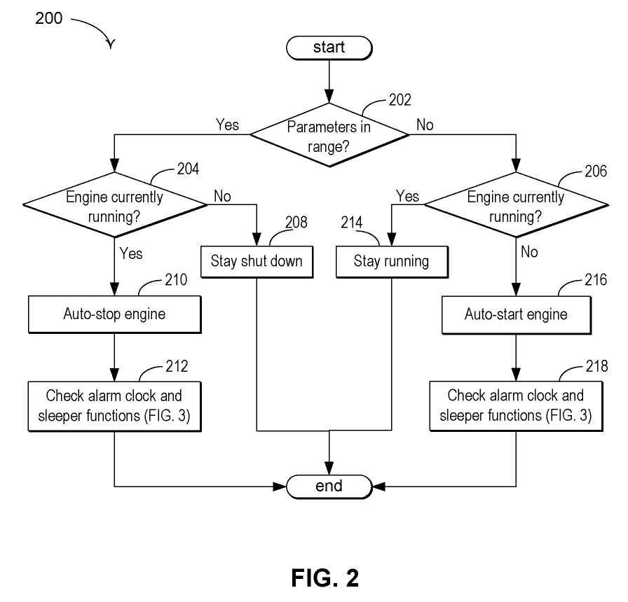

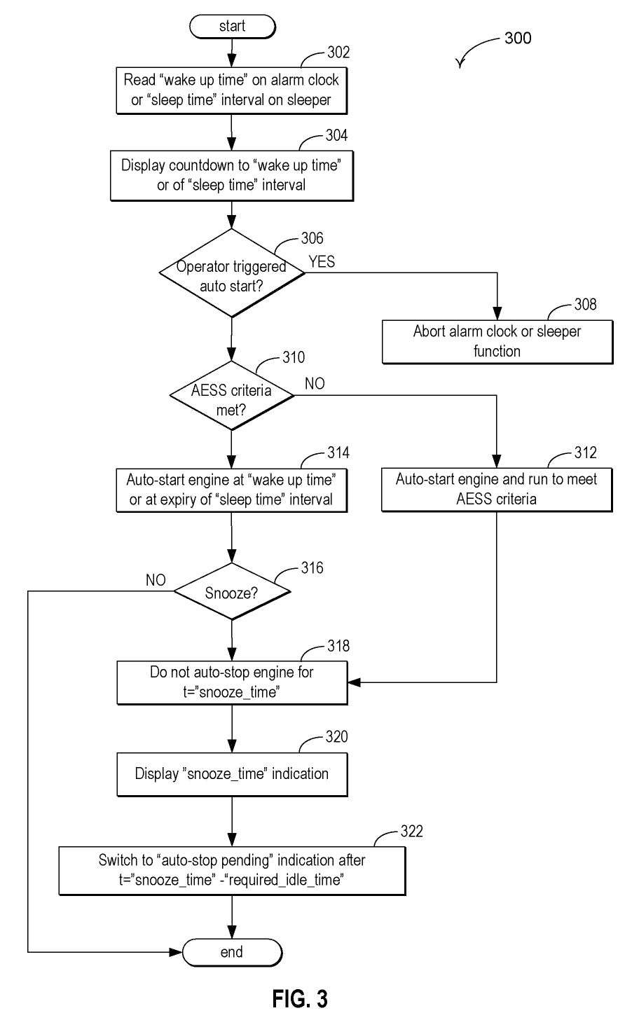

Locomotives, or other vehicles, may be configured with integrated locomotive control systems that improve operation efficiency and facilitate fleet management. One example of such a configuration is illustrated with reference to FIG. 1 wherein an Automatic Engine Start/Stop control system (AESS) monitors locomotive operating parameters, irrespective of whether the engine is running or stopped. The AESS may estimate the locomotive operating parameters and then evaluate them against desired operating conditions. Further, as elaborated in FIG. 2, the AESS may automatically start or stop an idle locomotive, as conditions warrant, without an operator triggered cue. Alternatively, the AESS may receive operator-triggered cues for engine start-up and/or shut-down. The AESS may be further coordinated with a clock function to perform a clock-scheduled auto-start, as elaborated in FIG. 3, based on the operating schedule of the locomotive. As such, locomotives operating with such integrated control systems may achieve improved fuel efficiency, consistent performance, timely departures and overall reduced operation costs.

FIG. 1 is a block diagram of an example vehicle system for a locomotive 100, configured to run on track 104. As depicted herein, in one example, the locomotive is a diesel electric vehicle operating a diesel engine 106 located within a main engine housing 102. However, in alternate embodiments of locomotive 100, alternate engine configurations may be employed, such as a gasoline engine or a biodiesel or natural gas engine, for example.

Locomotive operating crew and electronic components involved in locomotive systems control and management, for example controller 110, may be housed within a locomotive cab 108. In one example, controller 110 may include a computer control system. The locomotive control system may further comprise computer readable storage media including code for enabling an on-board monitoring of locomotive operation. Controller 110, overseeing locomotive systems control and management, may be configured to receive signals from a variety of sources in order to estimate locomotive operating parameters. Controller 110 may be further linked to a display 112, such as a diagnostic interface display, providing a user interface to the locomotive operating crew. Controller 110 may also be configured to operate an automatic engine start/stop control system on an idle locomotive 100, thereby enabling the locomotive engine to be automatically started and stopped upon fulfillment of AESS criteria. Alternatively, an operator may manually indicate an intention to motor the locomotive by moving a direction controller, herein depicted by reverser 114.

Engine 106 may be started with an engine starting system. In one example, a generator start may be performed wherein the electrical energy produced by a generator or alternator 116 may be used to start engine 106. Alternatively, the engine starting system may comprise a motor, such as an electric starter motor, or a compressed air motor, for example. It will also be appreciated that the engine may be started using energy in a battery system, or other appropriate energy sources.

The diesel engine 106 generates a torque that is transmitted to an alternator 116 along a drive shaft (not shown). The generated torque is used by alternator 116 to generate electricity for subsequent propagation of the vehicle. Locomotive engine 106 may be run at a constant speed, thereby generating a constant horsepower output, or at variable speed generating variable horse power output, based on operational demand. The electrical power generated in this manner may be referred to as the prime mover power. The electrical power may be transmitted along an electrical bus 117 to a variety of downstream electrical components. Based on the nature of the generated electrical output, the electrical bus may be a direct current (DC) bus (as depicted) or an alternating current (AC) bus.

Alternator 116 may be connected in series to one, or more, rectifiers (not shown) that convert the alternator's electrical output to DC electrical power prior to transmission along the DC bus 117. Based on the configuration of a downstream electrical component receiving power from the DC bus, one or more inverters 118 may be configured to invert the electrical power from the electrical bus prior to supplying electrical power to the downstream component. In one embodiment of locomotive 100, a single inverter 118 may supply AC electrical power from a DC electrical bus to a plurality of components. In an alternate embodiment, each of a plurality of distinct inverters may supply electrical power to a distinct component. It will be appreciated that in alternative embodiments, the locomotive may include one or more inverters connected to a switch that may be controlled to selectively provide electrical power to different components connected to the switch.

A traction motor 120, mounted on a truck 122 below the main engine housing 102, may receive electrical power from alternator 116 via the DC bus 117 to provide traction power to propel the locomotive. As described herein, traction motor 120 may be an AC motor. Accordingly, an inverter paired with the traction motor may convert the DC input to an appropriate AC input, such as a three-phase AC input, for subsequent use by the traction motor. In alternate embodiments, traction motor 120 may be a DC motor directly employing the output of the alternator 116 after rectification and transmission along the DC bus 117. One example locomotive configuration includes one inverter/traction motor pair per wheel-axle 124. As depicted herein, six pairs of inverter/traction motors are shown for each of six pairs of wheel-axle of the locomotive. In alternate embodiments, locomotive 100 may be configured with four inverter/traction motor pairs, for example. It will be appreciated that in alternative embodiments, a single inverter may be paired with a plurality of traction motors. Traction motor 120 may also be configured to act as a generator providing dynamic braking to brake locomotive 100. In particular, during dynamic braking, the traction motor may provide torque in a direction that is opposite from the rolling direction thereby generating electricity that is dissipated as heat by a grid of resistors 126 connected to the electrical bus. In one example, the grid includes stacks of resistive elements connected in series directly to the electrical bus. The stacks of resistive elements may be positioned proximate to the ceiling of main engine housing 102 in order to facilitate air cooling and heat dissipation from the grid.

Air brakes (not shown) making use of compressed air may be used by locomotive 100 as part of a vehicle braking system. The compressed air may be generated from intake air by compressor 128.

A multitude of motor driven airflow devices may be operated for temperature control of locomotive components. The airflow devices may include, but are not limited to, blowers, radiators, and fans. A variety of blowers 130 may be provided for the forced-air cooling of various electrical components. For example, a traction motor blower to cool traction motor 120 during periods of heavy work, an alternator blower to cool alternator 116 and a grid blower to cool the grid of resistors 126. Each blower may be driven by an AC or DC motor and accordingly may be configured to receive electrical power from DC bus 117 by way of a respective inverter.

Engine temperature is maintained in part by a radiator 132. Water may be circulated around engine 106 to absorb excess heat and contain the temperature within a desired range for efficient engine operation. The heated water may then be passed through radiator 132 wherein air blown through the radiator fan may cool the heated water. The radiator fan may be located in a horizontal configuration proximate to the rear ceiling of locomotive 100 such that upon blade rotation, air may be sucked from below and exhausted. A cooling system comprising a water-based coolant may optionally be used in conjunction with the radiator 132 to provide additional cooling of the engine.

An on-board electrical energy storage device, represented by battery 134 in this example, may also be linked to DC bus 117. A DC-DC converter (not shown) may be configured between DC bus 117 and battery 134 to allow the high voltage of the DC bus (for example in the range of 1000V) to be stepped down appropriately for use by the battery (for example in the range of 12-75V). In the case of a hybrid locomotive, the on-board electrical energy storage device may be in the form of high voltage batteries, such that the placement of an intermediate DC-DC converter may not be necessitated. The battery may be charged by running engine 106. The electrical energy stored in the battery may be used during a stand-by mode of engine operation, or when the engine is shut down, to operate various electronic components such as lights, on-board monitoring systems, microprocessors, processor displays, climate controls, and the like. Battery 134 may also be used to provide an initial charge to start-up engine 106 from a shut-down condition. In alternate embodiments, electrical energy storage device 134 may be a super-capacitor, for example.

Controller 110 may control the engine 106, in response to AESS instructions, by sending a command to the gamut of engine control hardware components such as invertors 118, relays (not shown), alternator 116, fuel pumps (not shown), etc. Controller 110 may monitor locomotive operating parameters in idle locomotive 100, operating in a stand-by mode or shut-down mode. Upon verifying that AESS criteria are met, a computer readable storage medium configured in controller 110 may execute code to appropriately auto-stop or auto-start engine 106 by enabling performance of an AESS routine, as further elaborated below in FIG. 2. Further, if it is desired to auto-start locomotive 100 from a shut-down mode at a preset time, or after a preset time interval, the desired settings may be incorporated into the AESS routine of FIG. 2. Accordingly, by performing an alarm clock/sleeper routine, as further elaborated in FIG. 3, the AESS may be configured to automatically start the engine at a selected clock time.

FIG. 2 depicts an AESS routine 200 that may be performed by controller 110 during a stand-by or shut-down mode of locomotive operation. In one example, the locomotive may be in a stand-by mode when parked on a siding for a long term with the engine running at an idling speed, and a computer control system of the locomotive maintained active. In another example, locomotive 100 may be shifted to a stand-by mode after 4000 hours of engine operation. In the shut-down mode, locomotive 100 may be stationary and parked, and further the engine may not be running. However, on-board electronics, such as an on-board locomotive monitoring system, or a computer control system of the locomotive are maintained active during the shut-down conditions. The AESS routine 200 may allow monitoring of a plurality of locomotive operating parameters to verify that they are at a desired condition. If the AESS criteria are met, and the engine is running, the engine may then be automatically shut-down. In this way, by reducing the idling time of the locomotive engine 106, fuel economy and reduced emission benefits may be achieved. In contrast, during locomotive shut-down conditions, a plurality of engine operating parameters may be monitored and further, the engine may be automatically started in response to any of the plurality of monitored locomotive operating conditions falling outside a respective desired condition. The engine may be stopped when the operating condition regains the desired condition. By maintaining the locomotive operating parameters in an operation ready-state at all times, locomotive efficiency may be improved.

Routine 200 may include, at 202, monitoring locomotive operating parameters and determining whether they are at a desired condition, such as within a desired range of values or above a desired threshold value. The parameters monitored may include, for example, ambient temperature, engine oil temperature, compressor air pressure, main air reserve pressure, battery voltage, a battery state of charge and brake cylinder pressure. In one example, only one of the plurality of locomotive operating parameters may be monitored and used to determine if AESS criteria are met. In another example, some or all of the locomotive operating parameters may be concurrently monitored and used to determine if AESS criteria are met. Upon estimating the conditions and verifying their values against a prescribed range of desired values, at 204 and 206, it is determined whether the engine is currently running.

If the locomotive operating parameter(s) are at the desired condition, and the engine is not currently running, that is the locomotive is in a shut-down mode, then at 208, the locomotive engine may be maintained in a shut-down mode. However, if the parameters are within range and the engine is currently running, that is the locomotive is in a stand-by mode, the engine may be automatically shut-down, or auto-stopped, at 210. At 212, controller 110 may check the alarm clock and sleeper function of the AESS to determine if a selected clock time for engine start has been indicated by the operator. Accordingly, an alarm clock/sleeper routine 300, as further elaborated in FIG. 3, may be performed wherein the automatic engine start/stop control system may be configured to automatically start the engine at a selected clock time.

If the parameters are not within range, and the engine is currently running, then at 214, the engine may be kept running to allow the parameters to be brought back to the desired condition. If any of the plurality of monitored locomotive operating parameters falls outside their respective desired condition, and further if the engine is not currently running, then at 216, the engine may be automatically started to enable the desired conditions to be regained. It will be appreciated that in alternate examples, the engine may be automatically started when any of the monitored locomotive operating parameters fall outside their respective desired conditions. In one example, if the battery charge has dissipated and consequently the battery state of charge has dropped, then the engine may be run to allow the electrical power generated by the engine to be used to recharge the battery and regain a desired battery state of charge. In another example, if the compressor air pressure has fallen below a desired value, then the engine may be run until the compressor is sufficiently full of compressed air and a compressed air storage pressure has been reached. It will be further appreciated that the threshold of a locomotive operating parameter at which the engine is automatically started may differ from the threshold at which the engine is automatically shut-down. In one example, the engine may be automatically started when the battery state of charge has dropped below 30%. In contrast, the engine may be run until a battery state of charge of 50% is reached, following which the engine may be automatically shut-down.

Subsequently, at 218, the controller may read the alarm clock and sleeper functions of the AESS to determine if a selected clock time has been indicated by the operator. Accordingly, controller 110 may perform alarm clock/sleeper routine 300 to determine if the engine should be kept running or auto-stopped. In this way, an automatic engine start/stop control system may be configured to monitor locomotive operating parameters during a locomotive stand-by and/or shut-down mode, and automatically start the engine when a locomotive operating parameter falls outside a desired condition, and then stop the engine when the operating condition regains its desired condition.

FIG. 3 depicts an alarm clock/sleeper routine 300 that may be incorporated into an AESS system in one embodiment. The routine allows a locomotive in a shut-down condition to be auto-started at a desired time point, based on the departure schedule of the locomotive. The selected clock time may be an absolute clock time or a relative clock time. The specified “wake-up time” and/or “sleep time” may be communicated to the AESS by an operator via display 112. In alternate embodiments, for example when a display is not available, the alarm clock/sleeper configurations may be communicated via programmable settings in the alarm clock/sleeper code. Upon starting the engine, an associated engine control system may monitor locomotive operating parameters and perform appropriate adjustments such that the locomotive engine may be in an operation-ready state at the desired time point. Consequently, the locomotive may be operated on demand from an operator without the requirement for prior maintenance procedures by service personnel.

In one example, if stationary locomotive 100 is scheduled to depart at 6 a.m., the AESS system may be configured with a selected clock time wherein the selected clock time includes an absolute clock time. Accordingly, at 5 a.m., the selected “wake-up time” for example, controller 110 may auto-start engine 106 and perform a maintenance routine on system components to verify AESS criteria are met, such as a compressor air pressure, a battery voltage, a battery state of charge, an engine temperature, etc. are within a desired range. Following maintenance procedures, controller 110 may prevent the engine 106 from being auto-stopped for a preselected duration and instead allow locomotive 100 to be kept in an idle state until the operating crew arrive and proceed to operate the locomotive.

In another example, if it is desired to auto-start the engine 106 after being parked in the yard for 10 hours, the AESS system may be configured with a selected clock time wherein the selected clock time includes a relative clock time. Further, the selected (relative) clock time may be a time interval, e.g. 10 hours, from a previous shut-down. As such, the AESS may indicate a selected “wake-up time” to be calculated based on a specified “sleep time” of 10 hours. Accordingly, 10 hours after a previous shut-down, controller 110 may auto-start engine 106, perform maintenance routines, and allow locomotive 100 to be kept in an idle state until the arrival of the operating crew. In this way, by incorporating time element features into an automatic engine start/stop system, and by performing routine 300, as elaborated below in FIG. 3, a control system for a locomotive operating on a schedule automatically starts the engine at the selected clock time while the vehicle is stationary. It will be appreciated that while the engine may not be running, the AESS maintains a computer control system of the locomotive active during the shut-down conditions. Alternatively, such operation may be used on towed locomotives in a shut-down or stand-by mode. Additionally, or optionally, operation of the AESS system may be suspended between the “wake-up time” and the “sleep time”.

At 302, the controller 110 reads a selected clock time. The selected clock time may be represented by a “wake-up time” specified on the alarm clock function or a “sleep time” interval specified on the sleeper function. The selected clock time may be adjusted based on a variety of schedule related parameters. In one aspect, the selected clock time is based on a calendar date and further based on whether the calendar date is a weekday or a weekend. In one example, the selected clock time may be input in a 5-1-1 week configuration wherein the clock time is adjusted based on whether it is one of the 5 weekdays, or whether it is a Saturday, or a Sunday. As such, in the 5-1-1 configuration, the locomotive may be auto-started at an earlier time, or after a shorter interval on weekdays and at a later time, or after a longer interval, on Saturdays and Sundays, based on the difference in schedule of the locomotive on a weekday versus a weekend day. It will be appreciated that in an alternate aspect, the selected clock time may be further adjusted depending on the day of the week. For example, the selected clock time may be earlier on a Monday and later on a Wednesday.

In another aspect, the selected clock time is based on whether the calendar date is a holiday whereon the locomotive may operate on a holiday schedule. In still another aspect, the selected time is adjusted depending on a calendar day. In one example, the day may be a day on which a time zone time is adjusted. Accordingly, the selected time may be adjusted to reflect the appropriate time in that time zone, such as a daylight saving time. In yet another aspect, the selected time may be a time interval from a previous shut-down of the locomotive. In this way, the selected time may be adjusted based on a calendar schedule to match the operation schedule of the locomotive 100.

At 304, the routine counts down the amount of time remaining until the specified “wake-up time”, and/or the end of the specified “sleep time” interval. An indication of the amount of time that has elapsed and/or the amount of time remaining in the countdown may be displayed on display 112 to notify the operator of the engine status. By specifying a time at when auto-start is desired, the engine may be maintained in a shut-down mode until the engine is required to be running, thereby reducing unwanted fuel usage and NOx emissions.

The engine may continue to remain in a shut-down mode of operation until the selected clock time unless prompted to start by alternate cues. At 306, routine 300 determines if an operator-triggered auto-start indication has been provided. The operator-triggered auto-start indication may be provided by the operator to indicate a sudden intention to motor and propel the locomotive. In one example, an operator-triggered auto-start may be indicated by the operator moving the reverser 114 from a center (“neutral”) position. In another example, a manual start may be indicated by an operator communicating an auto-start on the AESS system. Upon receiving an operator-triggered auto-start indication, at 308 the controller 110 may abort automatically starting the engine at the selected absolute or relative clock time, in anticipation of an imminent locomotive motion.

If at 306, an operator-triggered auto-start is not indicated, then at 310 the routine may verify if AESS criteria are met. That is, one or a plurality of locomotive operating parameters may be monitored, as in routine 200 (FIG. 2). The locomotive operating parameters may include compressor air pressure, brake cylinder air pressure and a battery state of charge for example, and verification that they are within a desired range. If a locomotive operating parameter falls outside the respective desired range, this may be perceived as an alternate auto-start cue. Accordingly, at 312, the AESS automatically starts the engine in response to an operating parameter falling outside a desired range and uses the electrical power generated by running engine 106 to return the parameter to within the desired range. In one example, if the brake cylinder pressure is determined to have fallen below a prescribed minimum threshold, then at 312, the engine may be auto-started to allow the compressor to compress air and raise the brake cylinder pressure.

If no operator-triggered auto-start is indicated at 306, and further if the locomotive operating parameters are within the desired range, at 314, routine 300 may continue counting down to the selected clock time and auto-start the engine 106 at the predefined “wake-up time”. In this way, a control system may automatically start the engine of a vehicle, such as a locomotive operating on a schedule, at a selected clock time based on the locomotive operating schedule, and while the vehicle is stationary. By performing a comprehensive check of engine components and operating parameters before starting the engine at a specified “wake-up time”, based on the selected clock time, a locomotive engine may be kept in an operation-ready state such that the locomotive may be propelled upon operator demand. Given that the engine may be started automatically at the selected clock time without operator or service personnel intervention, the possibility of human factor related delays and errors in locomotive operation may be reduced.

At 316, an auxiliary snooze attribute of the alarm clock/sleeper function configured on the AESS may be estimated. The “snooze” function may enable the automatic engine start/stop control system to maintain the engine operating for a selected duration after the automatic start, independent from the operating parameter, and then shut down the engine, thereby averting premature engine shut-down. If a desire to “snooze” has been indicated to the controller 110, then a specified “snooze_time” may be noted and at 318, the controller may not allow the engine to be auto-stopped for the duration of the “snooze_time”. For example, the AESS may maintain the engine operating for the preselected duration after the automatic start, independent from the operating parameter, and then later shut down the engine. In one embodiment, when in the snooze mode, at 320, the controller may be directed to display a “snooze-time” indicator, for example on the display 112, for the duration of the “snooze_time”. This may allow the operator to be notified of the operating snooze mode and may further indicate that at the end of the snoozing period, the engine may be idled for a required amount of time (“required_idle_time”) and then auto-stopped. To further notify the operator of the imminent auto-stop, at 322, the “snooze time” indication may be switched to an “auto stop pending” indication, for example on the display, after a time:

t=“snooze_time”−“required idle_time”

During this time, the display may further indicate a countdown (of the snooze interval) to auto-stop. In one example, the operator may note the indication of the end of the snooze mode and may opt to change AESS settings to prevent the pending auto-stop and instead may manually indicate (for example by changing the reverser 114 position) a desire to propel the locomotive immediately. If no snooze was desired at 316, the routine may end. In this way, routine engine assessments and engine operation may be performed responsive to a desired locomotive operating schedule, thereby reducing human intervention in engine control, and consequently, the possibility of human factor related delays and errors in locomotive operation.

It will be appreciated that in an alternate embodiment, the operations as described in FIGS. 2-3, may be executed by programmable code configured on computer readable storage media of a locomotive control system. In one example, the computer readable storage medium may comprise code for, during a first locomotive condition where the engine is shut-down, monitoring a plurality of locomotive operating parameters, and automatically starting the engine when any of the plurality of locomotive operating parameters falls outside respective desired conditions, and then stopping the engine when all of the monitored locomotive operating parameters regain the respective desired conditions. The computer readable storage medium may further comprise code for, during a second locomotive condition where the engine is shut-down, automatically starting the engine at a selected absolute clock time, or during a third locomotive condition where the engine is shut-down, automatically starting the engine at a selected relative clock time based on a time interval from a previous engine shut-down. During any of the second and third conditions, programmable code may further enable maintaining the engine running for at least a selected duration after the start, independent of any locomotive operating parameters. Further, the code may be programmed to execute, during a fourth locomotive condition where the engine is running, maintaining the engine operating after the selected clock time (absolute or relative), such as for a selected duration.

A statistical analysis of locomotive usage may be provided to allow for improved locomotive and fleet management. The computer readable storage medium of controller 110 may be configured to comprise code for tracking and tabulating a frequency of automatically starting the engine at a selected absolute clock time or relative clock time, a frequency of automatically starting the engine when a locomotive operating parameter falls outside a desired condition, and a frequency of automatically stopping the engine when a locomotive operating parameter is within a desired condition. The analysis may further include statistics pertaining to the recurrence of operator-triggered auto-start indications. The analysis may also include the reason for automatic engine start/stop. In one example, if the statistics indicate that locomotive 100 was automatically started/stopped frequently due to recurring drops in compressor air pressure, a compressor component defect may be perceived and addressed accordingly. In another example, if the statistics indicate that locomotive 100 spent a significant amount of time in a snooze mode, the locomotive's operation schedule may be rearranged within the fleet. In this way, system usage statistics and averages, locomotive performance statistics and averages, and fleet statistics and cumulatives may be computed. By providing a statistical analysis of the frequency of automatic engine start/stop and a compilation of time spent in the different modes (for e.g., stand-by mode, shut-down mode, snooze mode, suspend mode between “wake-up” and “sleep” times, etc.) may allow for statistical tracking of the locomotive and consequently improved locomotive management.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system for a vehicle, comprising:
an automatic engine start/stop control system configured to automatically start the engine at a selected clock time.

2. The system of claim 1 wherein the selected clock time includes an absolute clock time.

3. The system of claim 1 wherein the selected clock time includes a relative clock time.

4. The system of claim 1 wherein the vehicle is a locomotive operating on a schedule, and where the selected clock time is based on the locomotive operating schedule, and where the control system automatically starts the engine at the selected clock time while the vehicle is stationary.

5. The system of claim 1 wherein the automatic engine start/stop control system further starts the engine in response to an operating parameter falling outside a desired range.

6. The system of claim 5 wherein the automatic engine start/stop control system maintains the engine operating for a preselected duration after the automatic start, independent from the operating parameter, and then shuts down the engine.

7. The system of claim 1 wherein the selected clock time is adjusted depending on a calendar day.

8. The system of claim 7 wherein the selected clock time is based on a calendar date, and further based on whether the calendar date is a weekday.

9. The system of claim 8 wherein the selected clock time is based on whether the calendar date is a holiday.

10. A method of automatically starting an engine of a locomotive operating on a schedule, the method comprising:
during locomotive shut-down conditions:
monitoring a locomotive operating parameter, and automatically starting the engine when the locomotive operating parameter falls outside a desired condition, and then stopping the engine when the locomotive operating parameter regains the desired condition;
at a selected clock time, and if the engine is currently stopped, starting the engine, and then maintaining the engine operating for at least a selected duration, independent of the locomotive operating parameter; and
at the selected clock time, and if the engine is currently running, maintaining the engine operating for a least the selected duration, independent of the locomotive operating parameter.

11. The method of claim 10 wherein the locomotive operating parameter includes a battery state of charge.

12. The method of claim 11 further comprising adjusting the selected clock time based on a calendar date.

13. The method of claim 12 further comprising maintaining a computer control system of the locomotive active during the shut-down conditions.

14. The method of claim 11 wherein the selected clock time is a time interval from a previous engine shut-down.

15. The method of claim 11 wherein the selected clock time is an absolute clock time.

16. A computer readable storage medium for a locomotive control system, comprising:
code for, during a first locomotive condition where the engine is shut-down, monitoring a plurality of locomotive operating parameters, and automatically starting the engine when any of the plurality of monitored locomotive operating parameters falls outside respective desired ranges, and then stopping the engine when all of the monitored locomotive operating parameter are within the respective desired ranges;
code for, during a second locomotive condition where the engine is shut-down, automatically starting the engine at a selected absolute clock time;
code for, during a third locomotive condition where the engine is shut-down, automatically starting the engine at a selected relative clock time from a previous engine shut-down; and
code for, during a fourth locomotive condition where the engine is running, maintaining the engine operating after the selected absolute clock time or relative clock time.

17. The medium of claim 16 further comprising code for, during any of the second and third locomotive conditions, maintaining the engine running for at least a selected duration after the start.

18. The medium of claim 16, wherein the code for maintaining includes code for maintaining the engine operating for a selected duration.

19. The medium of claim 16 further comprising code for receiving a locomotive operating schedule, the schedule varying depending on a calendar day.

20. The medium of claim 16 further comprising code for, during any of the second and third locomotive conditions, receiving an operator-triggered auto-start indication; and aborting automatically starting the engine at the selected absolute clock time or relative clock time.

21. The medium of claim 20 wherein the indication is indicative of a locomotive operator having repositioned a locomotive direction controller.

22. The medium of claim 20 further comprising code for tracking a frequency of automatically starting the engine at a selected absolute clock time or relative clock time, a frequency of automatically starting the engine when a locomotive operating parameter falls outside a desired condition, and a frequency of automatically stopping the engine when a locomotive operating parameter regains the desired condition.
